(19) United States
(12) Patent Application Publication
(10) Pub. No.: US 2021/0201191 A1
(43) Pub. Date: Jul. 1, 2021

(54) METHOD AND SYSTEM FOR GENERATING MACHINE LEARNING BASED CLASSIFIERS FOR RECONFIGURABLE SENSOR

(71) Applicant: STMicroelectronics, Inc., Coppell, TX (US)

(72) Inventors: Mahesh CHOWDHARY, San Jose, CA (US); Mahaveer JAIN, Santa Clara, CA (US)

(21) Appl. No.: 16/728,822

(22) Filed: Dec. 27, 2019

(51) Int. Cl. G06N 20/00; G06N 5/00

(52) U.S. Cl. CPC G06N 20/00; G06N 5/003

(57) ABSTRACT

A sensor management system includes a cloud-based sensor configuration system and an electronic device. The electronic device includes a sensor unit. The sensor unit includes configuration data that controls operation of the sensor unit. The configuration data includes a classifier that classifies feature sets generated from sensor signals of the sensor unit. The electronic device sends sensor data to the cloud-based sensor configuration system. The cloud-based sensor configuration system analyzes the sensor data and generates a new classifier customized for the sensor unit based on the sensor data. The cloud-based sensor configuration system sends the new classifier to the electronic device. The electronic device replaces the classifier in the sensor unit with the new classifier.

### BACKGROUND

### Technical Field

The present disclosure relates to the field of sensors for electronic devices. The present disclosure relates more particularly to sensors that include analysis models.

### Description of the Related Art

Many electronic devices include sensor units that sense parameters associated with electronic devices. Typically, the configuration settings of the sensor unit are established before the electronic device is put to use in its intended fashion. Accordingly, the configuration settings of the sensor unit are not tailored to the circumstances of the electronic device and the habits of users that use the electronic device.

### BRIEF SUMMARY

One embodiment is a sensor management system. The sensor management system includes an electronic device and a cloud-based sensor configuration system. The electronic device includes a sensor unit. The sensor unit includes configuration data that controls the function and machine learning core of the sensor unit. After the electronic device and the sensor unit have been in use, the electronic device outputs sensor data or feature set to the cloud-based sensor configuration system. The sensor configuration system analyzes the sensor data or feature set and generates new configuration data customized for the sensor unit based on the input data. The sensor configuration system sends the new configuration data to the electronic device. The electronic device replaces the configuration data of the sensor unit with the new customized configuration data.

### BRIEF DESCRIPTION OF THE SEVERAL VIEWS OF THE DRAWINGS

FIG. 1 is a block diagram of a sensor management system, according to one embodiment.

FIG. 2 is a block diagram of a classifier, according to one embodiment.

FIG. 3 is a block diagram of a cloud-based sensor configuration system, according to one embodiment.

FIG. 4 is a block diagram of an electronic device, according to one embodiment.

FIG. 5 is a schematic diagram of a sensor unit, according to one embodiment.

FIG. 6 is a flow diagram of a method for managing a sensor unit, according to one embodiment.

FIG. 7 is a flow diagram of a method for managing a sensor unit, according to one embodiment.

FIG. 8 is a flow diagram of a method for managing a sensor unit, according to one embodiment.

FIG. 9 is a flow diagram of a method for managing a sensor unit, according to one embodiment.

FIG. 10 is a block diagram of a cloud-based sensor configuration system, according to one embodiment.

### DETAILED DESCRIPTION

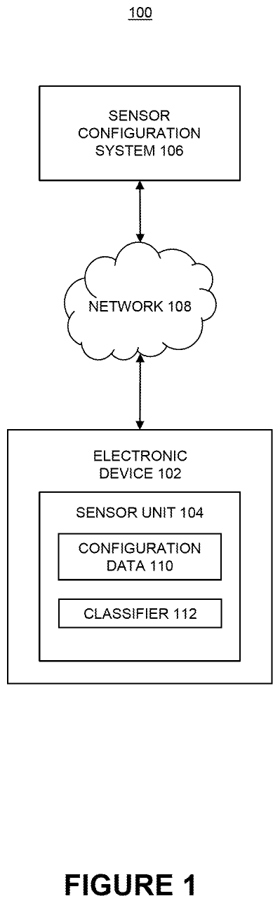

FIG. 1 is a block diagram of a sensor management system 100, according to one embodiment. The sensor management system 100 includes an electronic device 102 and a sensor configuration system 106. The electronic device 102 and the sensor configuration system 106 are communicatively coupled by a network 108. The electronic device 102 includes a sensor unit 104. The sensor configuration system 106 and the electronic device 102 cooperate to update a configuration of the sensor unit 104.

The sensor unit 104 generates sensor signals related to a context or activity of the electronic device 102. The sensor unit 104 generates feature data from the sensor signals by processing the sensor signals. The sensor unit 104 classifies an action or context of the electronic device 104 based on the feature data and configured machine learning model.

The sensor unit 104 includes configuration data 110. The configuration data 110 defines a configuration of the sensor unit 104. The configuration data 110 controls various operational aspects of the sensor unit 104. The operational aspects can include, but are not limited to, sampling rates for sampling sensor signals, filter parameters for filtering the sensor signals, formulas for computing feature data from the sensor signals, running machine learning core logic, and other operational aspects of the sensor unit 104.

The sensor unit 104 also includes a classifier 112. The classifier 112 receives the feature data for the various computed features. The classifier 112 generates classification data that classifies a context of the electronic device 102 based on the feature data. The configuration data 110 can include the configuration of the classifier 112. Further details regarding some example contexts are given below.

In one embodiment, the electronic device 102 is a personal electronic device of a user. The personal electronic device can include a smart phone, a smart watch, or another type of electronic device commonly carried, held, or worn by a user. In this case, the sensor unit 104 may include motion sensors such as an accelerometer and a gyroscope. The accelerometer senses linear acceleration of the personal electronic device 102 in one or more axes. The gyroscope senses angular or rotational motion of the electronic device 102 for one or more rotational axis. The accelerometer and the gyroscope output sensor signals indicative of the acceleration and angular motion for the various axes.

The sensor unit 104 generates feature data from the sensor signals. The feature data can include average acceleration for each of a plurality of axes, mean normal acceleration, instantaneous angular velocity for each of a plurality of rotational axes, a mean angle, a number of zero crossings, a peak to peak range of acceleration, a peak to peak range of angular motion, a peak to peak range of mean normal acceleration, a peak to peak range of mean normal angular motion, average long-term acceleration, average long term angular motion, energy values, numbers of zero crossings, intensity of motion for each of the various axes, a total intensity, or other types of features that can be computed based on acceleration and angular motion sensor signals. The configuration data 110 determines which features will be calculated from the sensor signals and how those features will be calculated.

The classifier 112 is a model that is configured to receive, as input, certain of the calculated features. The classifier 112 is configured to generate a classification for the context of the personal electronic device based on the values of the features. The classifier 112 includes one or more classification algorithms that expect as input the selected features and that classify the context of the personal electronic device into one of a fixed number of possible classifications.

The contexts can include various ways that the personal electronic device 102 can be carried, including, but not limited to, in a pocket, in a hand, on a left wrist, on a right wrist, strapped to an arm, or other ways that the personal electronic device can be carried or worn. The context can include various types of exercise that can be performed by a user while carrying or wearing the personal electronic device, including, but not limited to, walking outdoors, jogging outdoors, street biking, mountain biking, climbing stairs, running on a treadmill, riding a stationary bicycle, swimming, rowing, weightlifting, or other types of exercise. The contexts can also include various types of transportation including whether the user is driving a car, riding in a car, riding in a bus, riding on a train, riding on an airplane, or other types of transportation. The contexts can include various movements of the electronic device 102 such as raising the electronic device 102 to a display of the electronic device 102, double-tapping a touch sensitive display, rotating the electronic device 102 clockwise or counterclockwise, swiping the touch sensitive display in various directions, setting the electronic device 102 facedown, setting the electronic device faceup, or other types of motions or gestures that can be made in relation to the personal electronic device 102.

In one embodiment, the classifier 112 may initially correspond to a standard classifier that comes standard with the personal electronic device 102. In this case, the classifier 112 may initially not be very accurate because it is not generated based on the personal movements, habits, or other characteristics of the user. The classifier 112 may misclassify exercise, transportation, or gestures made by the user with the personal electronic device because the user may not move or use the electronic device 102 in ways that align with an initial training of the classifier 112. The failure to properly classify contexts of the personal electronic device 102 can have an adverse impact on the satisfaction of the user with the electronic device.

The sensor management system 100 utilizes the sensor configuration system 106 to update the configuration data 110 of the sensor unit 104. In particular, the sensor configuration system 106 generates configuration data 110 that is customized to the electronic device 102 based on data obtained from the sensor unit 104. Customized configuration data is then pushed down to and installed in the sensor unit 104.

The electronic device 102 communicates with the sensor unit 104 and with the sensor configuration system 106. The electronic device 102 receives data from the sensor unit 104. The electronic device 102 processes the data received from the sensor unit 104 and sends it to the sensor configuration system 106 via the network 108. The sensor configuration system 106 can then generate customized configuration data 110 including a customized classifier 112 based on the data received from the electronic device 102, as will be described in more detail below.

In one embodiment, the electronic device 102 receives raw sensor data from the sensor unit 104. The electronic device 102 also receives classification data from the sensor unit 104. The classification data corresponds to how the classifier 112 has previously classified contexts of the electronic device 102. The electronic device 102 can also convert sensor data to feature data before sending to Cloud in order to reduce the data traffic. The electronic device 102 also receives interrupts from the sensor unit 104.

In one embodiment, the electronic device 102 generates label data including labels for the raw sensor data or for sets of features from the feature data. The labels correspond to the correct context of the electronic device for a given portion of the raw sensor data. The labels can be used by the sensor configuration system 106 to generate customized configuration data for the sensor unit 104.

In one embodiment, the labels are generated based on user input indicating the contexts for various periods of time. The electronic device 102 may include one or more applications that enables users to specify an activity that they will be performing. For example, a fitness tracking application may enable users to select a type of exercise from a list of exercises prior to beginning a workout. The electronic device 102 can use this exercise selection to label certain portions of the sensor data. In another example, the electronic device may include a navigation application that enables users to select a mode of transportation and then navigates the user to a selected destination based on that mode of transportation. The electronic device 102 can also use interrupts generated by the sensor unit 104 to assist in labeling various activities.

The electronic device 102 sends the sensor data and the label data to the sensor configuration system 106. The electronic device 102 may also send feature data to the sensor configuration system 106 including feature values previously generated by the sensor unit 104 or by the electronic device 102 from the sensor data.

The electronic device sends the sensor data including the label data, the feature data, and digitized versions of the sensor signals to the sensor configuration system 106 via the network 108. The network 108 can include one or more networks such as the Internet, local area networks, wireless networks, and wired networks. The network 108 can include any combination of networks that enables the electronic device to communicate with the sensor configuration system 106.

After the sensor configuration system 106 receives the various types of data from the electronic device 102, the sensor configuration system 106 analyzes the sensor data and the label data with one or more analysis processes. The sensor configuration system 106 generates updated, customized configuration data 110 for the sensor unit 104 based on the sensor data, the label data and previous configuration.

In one embodiment, the sensor configuration system generates an updated, customized classifier 112 for the sensor unit 104 based on one or more machine learning processes. The sensor configuration system 106 generates training set data from the sensor data and the labeled data. The sensor configuration system 106 utilizes the training set data to train a new classifier based on the one or more machine learning processes.

In one embodiment, the sensor configuration system 106 generates one or more new classifiers using the training set data and measures the accuracy of each new classifier. The sensor configuration system 106 compares the accuracies of each new classifier to each other and to the classifier currently installed in the sensor unit 104. The sensor configuration system 106 selects the new classifier that has the highest accuracy in generating classifications that match the labels. The sensor configuration system 106 provides the selected new classifier to the electronic device 102 via the network 108. The electronic device 102 then replaces the classifier 112 in the sensor unit 104 with the new classifier selected by the sensor configuration system 106.

The updated classifier is customized based on the data provided by the electronic device 102 to the sensor configuration system 106. The labeled sensor data enables the sensor configuration system 106 to generate a classifier 112 that is customized to the particular electronic device 102 based on the characteristics of the electronic device 102 and the way that the user uses the electronic device 102. The result is that the updated classifier more accurately classifies contexts of the electronic device 102. This can lead to a more satisfying experience of the user with the electronic device 102.

While the description herein discusses embodiments in which the electronic device 102 is a personal electronic device, other types of electronic devices can be utilized without departing from the scope of the present disclosure. For example, the electronic device can be an industrial node including a sensor unit 104. The industrial node uses the sensor unit 104 to monitor the context of industrial equipment. The industrial node outputs sensor data to the sensor configuration system 106. The industrial node receives new configuration data from the sensor configuration system.

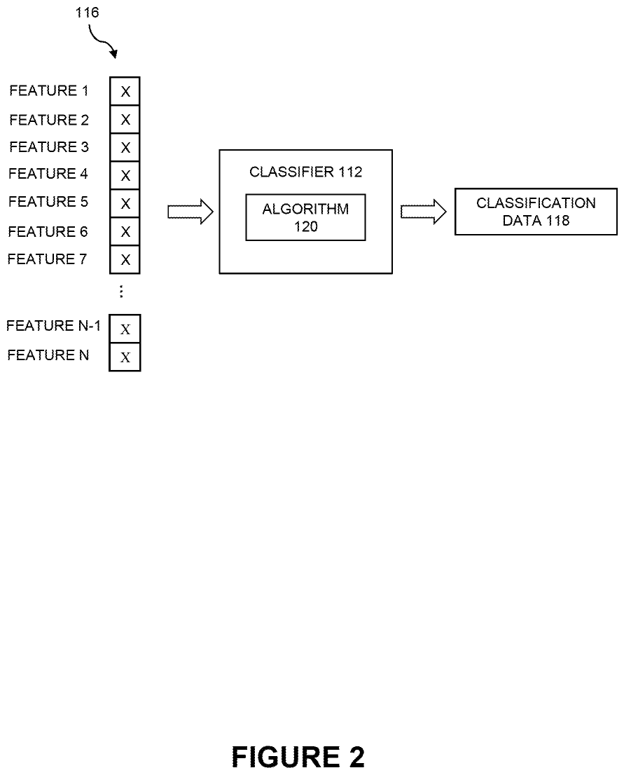

FIG. 2 is an illustration of operation of a classifier 112, according to one embodiment. The classifier receives as input, a feature set 116. The classifier 112 processes the feature set 116 with a classifier algorithm or function. The classifier 112 outputs classification data 118. The classification data 118 indicates a classification for the context of the electronic device 102 for the period of time represented by the feature set 116.

The classifier 112 includes an algorithm 120. The algorithm 120 defines a function for classifying contexts of the electronic device 102. The algorithm defines an expected number of inputs. Each input corresponds to a type of feature generated from the sensor signals of the sensor unit 104. In the example of FIG. 2, the algorithm 120 expects N input features.

The feature set 116 includes N rows or data fields. Each row or data field corresponds to a particular type of feature. The number of data fields or rows in the feature set 116 corresponds to the number of inputs expected by classifier 112 as defined by the algorithm 120.

In an example in which the electronic device 102 is a smart phone or a smart watch, the features 1-N can include some of the types of features described above in relation to FIG. 1. Feature 1 may correspond to mean linear acceleration along an X axis, feature 2 may correspond to mean linear acceleration along a Y axis, feature 3 may correspond to mean linear acceleration along a Z axis, feature 4 may correspond to mean angular motion along a first axis of rotation, feature 5 may correspond to maximum angular motion along a second axis of rotation, and so on. The feature set 116 may include feature types other than those described herein without departing from the scope of the present disclosure.

In one embodiment, the feature sets 116 are feature vectors. Each data field of the feature vector corresponds to a particular feature type. Each data field includes a feature value for that feature. Each feature set 116 may include multiple feature vectors each including multiple feature values from a particular period of time.

In one embodiment, the classifier 112 includes decision trees. In this case, the algorithm 120 defines a plurality of decision nodes. Each decision node tests one of the features from the feature set 116 in accordance with a decision rule. Each decision node includes multiple branches that can be taken depending on how the value of the corresponding feature aligns with the decision rule for that decision node. The final branch in a path corresponds to a classification for the feature vector. Accordingly, when the feature set 116 is input into the decision tree, the feature set takes a path through the decision nodes dependent on the values of the various features and finally arrives at a classification.

The decision tree may be generated with a machine learning process. The machine learning process is a supervised machine learning process. The supervised machine learning process is performed with training set data. The training set data includes a plurality of feature sets and a plurality of labels. Each feature set is labeled with a known classification. During the machine learning process, the feature sets are provided to the decision tree. The decision tree passes the feature sets through a pathway of nodes based on initial decision rules. After the feature sets have been passed through the decision tree, the classifications for the feature sets are compared to the known labels and the overall accuracy of the decision tree is assessed. The machine learning process then adjusts the arrangement of decision nodes and the decision rules for the decision nodes. The feature sets are then passed through the decision tree again and classified. The accuracy of the classification for the feature sets is again assessed and the algorithm 120 is adjusted. The process of classification, accuracy checking, and adjustment of the algorithm are performed repeatedly until the accuracy of the decision tree no longer increases or until other conditions are met. The result of this process is that the decision tree is trained to reproduce the labels for the training set.

While the discussion herein describes an example in which the classifier 112 is a decision tree, other types of classifiers can be utilized without departing from the scope of the present disclosure. For example, logistic regression classifiers, naïve Bayes classifiers, stochastic gradient descent classifiers, K nearest neighbors classifiers, random forest classifiers, support vector machine classifiers, or other types of classifiers can be used in accordance with principles of the present disclosure.

As will be described in more detail below, the sensor configuration system 106 generates updated classifiers for the sensor unit 104. The sensor configuration system 106 also generates other types of configuration data 110 for the sensor unit 104. The sensor configuration system 106 generates the updated classifiers 112 and the configuration data 110 based on sensor data to the sensor configuration system 106 by the electronic device 102.

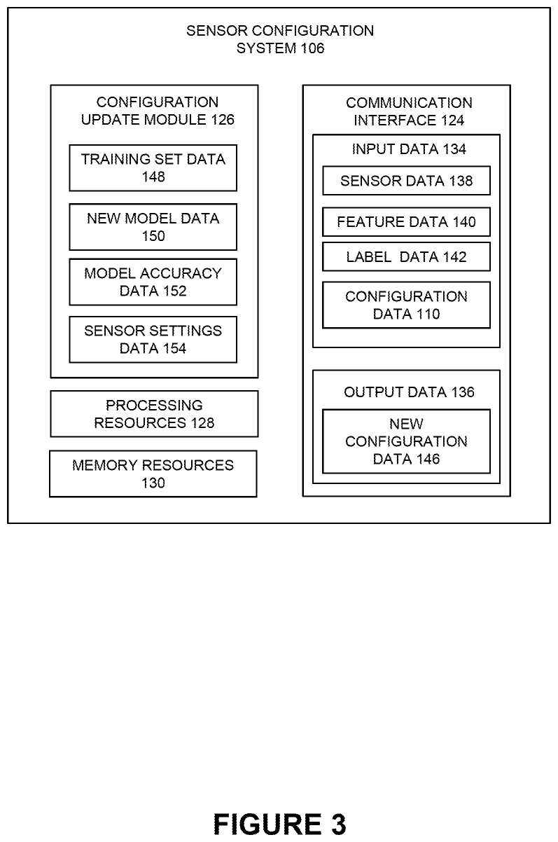

FIG. 3 is a block diagram of a sensor configuration system 106, according to one embodiment. The sensor configuration system 106 is a cloud-based sensor configuration system. The sensor configuration system 106 utilizes cloud computing resources to generate updated configuration data for the sensor unit 104. The sensor configuration system 106 communicates with the electronic device 102 via one or more networks 108. The sensor configuration system 106 advantageously utilizes cloud-based computing resources to generate updated configuration data for the sensor unit 104.

The sensor configuration system 106 includes a communication interface 124, a configuration update module 126, processing resources 128, and memory resources 130. The components of the sensor configuration system 106 cooperate together to efficiently and effectively generate customized configuration data for the sensor unit 104.

The communication interface 124 receives input data 134 from the electronic device 102. The communication interface 124 provides output data 136 to the electronic device 102. The communication interface 124 communicates with the electronic device 102 via the networks 108.

The input data 134 can include sensor data 138. The electronic device 102 can obtain the sensor data 138 from the sensor unit 104. The sensor data can include digitized versions of sensor signals output by the sensors of the sensor unit 104. In the example in which the sensor unit 104 includes an accelerometer and a gyroscope, the raw sensor data 134 can include the raw acceleration data and the raw rotational motion data provided by the accelerometer and the gyroscope.

The input data 134 can include feature data 140. The feature data can include data generated for each of a plurality of features from the sensor signals. In one example, many features can be extracted or computed from the sensor signals. The feature data 140 can include data computed or extracted from the sensor signals for each of a plurality of features.

The feature data 140 can include a plurality of feature sets each generated from sensor data from a particular window of time. For example, as described in relation to FIG. 2, the classifier 112 of the sensor unit 104 receives a feature set and generates a classification for the feature set. The feature set can correspond to feature sets that have been provided to the classifier 112 of the sensor unit 104 in the past. Accordingly, the sensor configuration system 106 receives a plurality of feature sets that have been previously classified by the classifier 112 of the sensor unit 104.

In one embodiment the sensor configuration system 106 does not receive the feature data 140 from the electronic device 102. Instead the sensor configuration system 106 can generate the feature data 140 from the sensor data 138. Additionally, or alternatively, the sensor configuration system 106 can receive the feature data 140 from the electronic device 102 and can generate adjusted feature data from the sensor data 138 for training purposes, as will be described in more detail below.

The input data 134 can include label data 142. The label data 142 includes, for each feature set from the feature data 140, a label. The label is a correct classification for that feature set. The correct classification corresponds to a correct context of the electronic device 102 associated with the period of time associated with the feature set. As described previously, the label data 142 can be generated by the electronic device 102.

The input data 134 can include configuration data 110. The configuration data 110 corresponds to the current configuration data installed on the sensor unit 104. The configuration data 110 can include the current classifier 112 installed on the sensor unit 104. The configuration data 110 can also include other configuration settings for acquiring sensor signals, processing the sensor signals, and for generating feature data from the sensor signals. In an example in which the sensor unit 104 includes motion sensors such as accelerometers and gyroscopes, the configuration data 110 can include configuration settings such as sampling rates for sampling sensor signals from the motion sensors, filter settings for filtering the sampled sensor signals, window sizes for generating feature sets from the sensor data 138, feature generation settings for calculating or generating feature sets from the sensor data 138, and other types of configuration data for configuring the sensor unit 104. Other types of sensor units 104 can have configuration data other than that described above without departing from the scope of the present disclosure. In one embodiment, the sensor data 138 includes the feature data 140, the label data 142, and the configuration data 110.

The output data 136 can include new configuration data 146. The new configuration data 146 includes new configuration settings to be installed in the sensor unit 104. The new configuration data 146 can include a new classifier, new filter settings, new feature generation settings, and other types of configuration data for configuring the sensor unit 104. The sensor configuration system 106 pushes the new configuration data 146 to the electronic device 102. The electronic device 102 installs the new configuration data 146 in the sensor unit 104.

The configuration update module 126 generates the new configuration data 146. The configuration update module 126 receives the input data 134 from the communication interface 124. The configuration update module 126 then performs various operations to generate new configuration data 146 in accordance with the input data 134 received from the sensor unit 104. In this way, the sensor configuration system 106 generates new configuration data 146 that is customized for the sensor unit 104 based on how the electronic device 102 has been used in the past.

In one embodiment, the configuration update module 126 generates training set data 148 from the input data 134. The training set data 148 includes the feature data 140 and the label data 142. The training set data 148 is used in one or more machine learning processes to generate a new classifier that can be provided to the sensor unit 104 with the new configuration data 146.

The configuration update module 126 utilizes the training set data 148 to train a new classifier. The training set data 148 includes a plurality of feature sets each matched to a label. During the machine learning process, the feature sets are passed to the new classifier and the new classifier generates a classification for each feature set. The classifications for each feature set are compared to the labels to determine the current accuracy of the new classifier. The internal parameters of the new classifier are then adjusted, the feature sets are passed to the classifier, classifications are generated, and the classifications are compared to the labels. This process continues in iterations until the accuracy of the new classifier can no longer be improved or until other selected conditions are met.

The configuration update module 126 generates new classifier data 150. The new classifier data 150 includes the new classifier that has been trained with the machine learning process.

In one embodiment, a portion of the feature data 140 and the label data are reserved from the training set data. This reserved portion is used as test data to test the accuracy of the classifier. The test data is not used during the training process. Instead the test data is used after the training process to further assess the accuracy of the classifier with feature sets and labels that were not used during training.

In one embodiment, sensor data from electronics device is stored in a staging buffer after converting to feature data. The sensor configuration unit can take the decision of generating new configuration based on the accuracy, Kappa statistics, and relative absolute data using current configuration data. The sensor configuration unit will also check the dataset imbalance and total feature data length. The checks on data imbalance includes test to check if new data improves the data balancing of the current model or if new data is already balanced. The new configuration will only be generated if the length of the new feature data is greater than 5% of the current configuration training data.

The configuration update module 126 generates accuracy data 152. The accuracy data 152 indicates the accuracy of the new classifier. The accuracy data 152 can include various types of accuracy data including percentage of correct classifications, error function data, Kappa statistics, relative absolute error data, root relative squared error data, and other types of data for measuring the accuracy of the new classifier.

The model accuracy data 152 can also include accuracy data for the currently installed classifier 112 of the sensor unit 104. The configuration update module 126 can compare the accuracy of the new classifier to the accuracy of the currently installed classifier. If the new classifier performs better than the currently installed classifier 112 as indicated by the accuracy data 152, then the sensor configuration system 106 may push the new classifier to the sensor unit 104.

In one embodiment, the input data 134 can include accuracy data associated with the currently installed classifier 112. In other words, accuracy data associated with the currently installed classifier 112 can be provided to the sensor configuration system 106 by the electronic device 104.

In one embodiment, the sensor configuration system 106 generates accuracy data 152 for the currently installed classifier 112. The configuration data 110 received by the communication interface 124 can include the current classifier 112. The configuration update module 126 can pass the feature data 140 to the current classifier 112 and compare the generated classifications to the labeled data 142. In this way, the configuration update module 126 can generate accuracy data 152 for the currently installed classifier 112.

In one embodiment, the configuration update module 126 generates a new classifier that receives a different set of features than those of the current classifier. Referring to FIG. 2, each feature set for the currently installed classifier 112 includes values for N features. The configuration update module 126 may generate a new classifier that does not receive the same N features. The new classifier may be configured to receive feature sets that include one or more features not included in the feature sets for the current classifier 112. Additionally, or alternatively, the new classifier may be configured to receive feature sets that do not include one or more of the N features included in the feature sets for the current classifier 112. Accordingly, the new classifier generated by the sensor configuration system 106 can receive different sets of features than the currently installed classifier 112.

In one embodiment, the configuration update module 126 generates and trains a plurality of new classifiers. The various classifiers can include many different sets of features. The configuration update module 126 generates accuracy data 152 for each of the new classifiers. The configuration update module 126 can select the new classifier that has the highest accuracy in accordance with one or more accuracy measurement parameters.

In one embodiment, the configuration update module 126 generates and trains a plurality of new classifiers for each of a variety of sets of features. If there are M types of features that can be used for feature sets, then the configuration update module 126 can generate and train a new classifier whose feature sets include all M feature types. The configuration update module 126 can also generate and train a new classifier for each possible subset of M-1 feature types. The configuration update module 126 can generate and train a new classifier for each possible subset of M-2 feature types and so forth. The configuration update module 126 can generate and train new classifiers for a large number of different sets of feature types. The configuration update module 126 can generate accuracy data 152 for each new classifier. The configuration update module 126 can select the most accurate new classifier to be pushed and installed on the sensor unit 104.

If the feature data 140 does not include feature types that may be tested for new classifiers, the configuration update module 126 can generate these feature types from the sensor data 138. Alternatively, the sensor configuration system 106 can request that the electronic device 102 generates the requested new feature types from the sensor data 130. The training set data 148 can be adjusted to include the new feature types.

In one embodiment, the configuration update module 126 generates sensor settings data 154. The sensor settings data 154 can include various settings for receiving and processing the sensor signals output by the sensors of the sensor unit 104. Generating the new classifiers can include selecting various sensor settings included in the sensor settings data 154. For example, the configuration update module 126 can select various sensor settings based on which the feature data should be generated from the sensor data.

In one embodiment, the sensor settings data 154 includes sampling rates. The configuration update module 126 may select sampling rates for collecting data from the sensors. The sampling rates can affect how the feature data is generated. If a sampling rate is too low, meaningful information may be lost when generating values for various of the features to be provided to the classifier. If a sampling rate is too high, generating feature values may be unduly resource intensive in terms of processing and memory resources. Accordingly, the configuration update module 126 can select or adjust sampling rates for the sensor unit 104.

In one embodiment, the sensor settings data 154 includes filter settings. The configuration update module 126 may select filter settings for filtering the sensor signals provided by the sensors of the sensor unit 104. Accordingly, the sensor signals are passed through one or more filters before the feature values are generated. The filters can include low-pass filters, high-pass filters, band pass filters, or other types of filters. The sensor configuration system 106 can select one or more types of filters as well as the cutoff frequencies for the filters. The configuration update module 126 can select the filter parameters based on analysis of the sensor data 138 and/or the feature data 140. In the example of motion sensors, the selection of the filter types and the frequencies of interest can be done by finding, in the sensor data, frequencies of significant energy and nonoverlapping regions between classes. These selections can be made by performing frequency domain analysis on the raw sensor data. The frequency domain analysis can include performing Fourier transforms, such as fast Fourier transforms or other types of transforms on the sensor data. The filter settings may also include transfer functions and Fourier transforms.

In one embodiment, the sensor settings data 154 includes window size settings. The configuration update module 126 may select window sizes for generating features. The window size corresponds to the length of time for which sensor data is compiled and feature values are generated. For example, a window size for generating a feature set may be less than a second, several seconds, several minutes, or several hours based on the type of the sensor, the type of the electronic device 104, and the types of expected possible contexts for classification. The configuration update module 126 can select a window size for generating feature sets with the sensor unit 104.

The sensor configuration system 106 can generate, train, and test new classifiers with various different sensor settings applied to the sensor data 138. Accordingly, a new classifier can be selected not only based on feature types but based on selected sensor settings.

After the configuration update module 126 has identified selected sensor settings and a new classifier, the configuration update module 126 generates new configuration data 146. The new configuration data 146 includes the new classifier and the sensor settings data 154. The new configuration data 146 can also include other types of data associated with a configuration for the sensor unit 104.

After the new configuration data has been generated by the configuration update module 126, the communication interface 124 outputs the new configuration data 146 to the electronic device 102. The electronic device 102 can then apply the new configuration data to the sensor unit 104. In particular, the electronic device 102 replaces the previous configuration data with the new configuration data. The sensor unit 104 will then include configuration data 110 based on the new configuration data 146. The configuration data 110 includes a classifier 112 that is the new classifier selected by the configuration update module 126.

In one embodiment, the sensor configuration system 106 can select features for a new classifier by analyzing the feature data 140. Some of the features may be highly correlated with each other, and therefore redundant. The configuration update module 126 can determine whether some features can be dropped for the new classifier. The sensor configuration system 106 can utilize cross-correlation techniques, entropy/information gain techniques, Bhattacharya distance techniques or other analysis techniques to identify features that can be removed without sacrificing accuracy of classification. After features have been selected for the new classifier, the sensor configuration system 106 can generate one or more new classifiers using the machine learning techniques described above.

The processing resources 128 include one or more processors. The memory resources 130 include one or more memories configured as computer readable media capable of storing software instructions and other data. The processing resources 152 are capable of executing software instructions stored on the computer readable media. In one embodiment, the various components of the sensor configuration system 106 utilize the processing resources 128 and the memory resources 130 to assist in performing their various functions. The processing resources 128 and the memory resources 130 can correspond to a cloud computing resources. Accordingly, the processing resources 128 and the memory resources 130 can be part of a cloud computing environment. Accordingly, the processing resources 128 and the memory resources 130 can include disparately located physical and virtual resources.

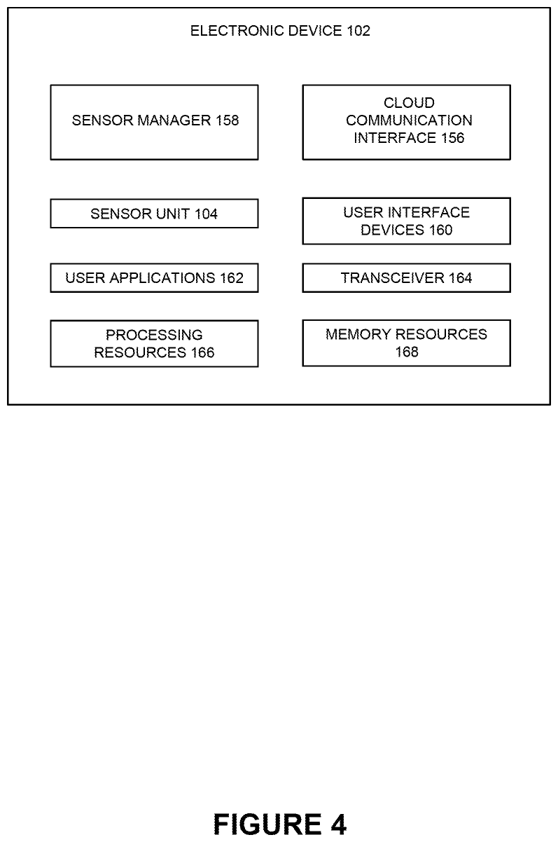

FIG. 4 is a block diagram of an electronic device 102, according to one embodiment. The electronic device 102 communicates with the cloud-based sensor configuration system 106. The electronic device 102 includes a cloud communication interface 156, a sensor manager 158, user interface devices 160, the sensor unit 104, user applications 162, one or more transceivers 164, processing resources 166, and memory resources 168.

The cloud communication interface 156 manages communication between the electronic device 102 and the sensor configuration system 106. The cloud communication interface 156 manages the transmission of sensor related data to the sensor configuration system 106. The cloud communication interface 156 manages reception of new configuration data 146 from the sensor configuration system 106.

The sensor manager 158 updates the sensor unit 104 with the new configuration data 146. In particular, when the electronic device 102 receives new configuration data from the sensor configuration system 106, the sensor manager 158 writes the new configuration data 146 to the sensor unit 104. Accordingly, the sensor manager 158 updates the configuration data 110 of the sensor unit 104.

The sensor manager 158 receives data from the sensor unit 104. The sensor manager 158 can receive one or more of analog sensor data, digital sensor data, filtered sensor data, feature data, classification data, interrupt data, or other types of data from the sensor unit 104. The sensor manager can process the data received from the sensor unit 104 in preparation for providing sensor related data to the sensor configuration system 106.

In one embodiment, the sensor manager 158 labels the feature data received from the sensor unit 104. The sensor manager 158 can generate the labels. Additionally, or alternatively, the sensor manager 158 can receive labels based on input received from the user, and/or the user applications 162, as will be described in more detail below.

The sensor manager 158 can also monitor the sensor unit 104. For example, the sensor manager 158 can monitor the classifier 112 to determine whether the classifier 112 is functioning in accordance with the most up-to-date configuration data. If there are multiple sensor units 104 associated with the electronic device 102, the sensor manager 115 can manage the configuration settings and the classifiers for each of the sensor units.

The sensor manager 158 can cause the sensor unit 104 to change a data output rate, sampling rate, or filter settings. For example, if the classifier 112 is an activity recognition classifier and a particular activity is detected, the sensor manager can trigger the sensor unit 104 to change a dynamic range of the accelerometer, to change a data output rate, or to change filter settings based on the type of detected activity. The sensor manager 158 may not change the data output rate settings if the classifier 112 has not been updated, in one embodiment.

The user interface devices 160 include any devices or functionality that enable a user to interact with the electronic device 102. In the example of a smart phone, the user interface devices can include a touchscreen, input buttons, power button, volume buttons, a home button, a microphone, a speaker, or any other devices or functionality that enable a user to provide input to the electronic device 102 or to receive output from the electronic device 102.

The user applications 162 include applications that can be utilized by a user of the electronic device 102 for various purposes. In one example, the user applications 162 include an exercise monitoring application. The exercise monitoring application enables the user to track parameters of various exercises performed by the user including walking, jogging, riding a bicycle, running on a treadmill, riding a stationary bicycle, weightlifting, running stairs, or other types of exercises. In some cases, the user applications 162 may receive classification data from the sensor unit 104. The classification data can include a classification of an activity performed by the user based on data output by the sensors of the sensor unit 104. As described previously, the classifier 112 can receive feature values based on sensor data and can generate a classification for context of the user electronic device, such as an activity being performed by the user while holding or wearing the electronic device 102. The user applications 162 can include navigation systems that help users navigate between destinations with a selected mode of transportation. The navigation system can rely on the sensor unit 104 to detect a mode of transportation. The classifier 112 can classify the mode of transportation. The user applications 162 can include many other types of user applications without departing from the scope of the present disclosure.

The electronic device 102 includes a transceiver 164. The transceiver 164 can wirelessly transmit and receive data. In one embodiment, when the cloud communication interface communicates with the sensor configuration system 106, the cloud communication interface 156 causes the transceiver 164 to output data wirelessly. Additionally, the transceiver 150 receives wireless data from the sensor configuration system 106 via the networks 108.

The processing resources 166 include one or more processors. The memory resources 168 include one or more memories configured as computer readable media capable of storing software instructions and other data. The processing resources 166 are capable of executing software instructions stored on the computer readable media. In one embodiment, the various components of the electronic device 102 utilize the processing resources 166 and the memory resources 168 to assist in performing their various functions.

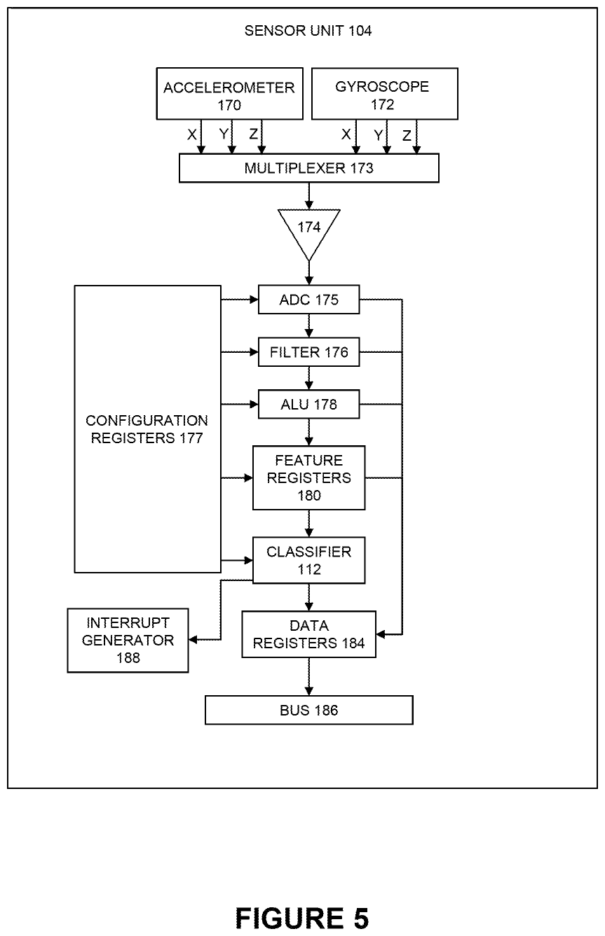

FIG. 5 is a schematic diagram of a sensor unit 104, according to one embodiment. In the example of FIG. 5, the sensor unit 104 is a motion sensor unit. Accordingly, the sensor unit 104 of FIG. 5 includes an accelerometer 170 and a gyroscope 172. Those of skill in the art will recognize, in light of the present disclosure, that a sensor unit 104 in accordance with principles of the present disclosure can include sensors other than motion sensors without departing from the scope of the present disclosure.

The accelerometer 170 generates linear acceleration signals for each of an X axis, a Y, and a Z axis. The linear acceleration signals can include analog linear acceleration signals. The linear acceleration signals are provided to the multiplexer 173.

The gyroscope 172 generates rotational motion signals for rotation about each of an X axis, a Y axis, and a Z axis. The rotational motion signals can include analog rotational motion signals. The rotational motion signals are provided to the multiplexer 173.

The multiplexer alternately provides the X, Y, and Z acceleration and rotational signals to an amplifier 174. The amplifier 174 amplifies the signals and provides them to an analog-to-digital converter 175.

The analog-to-digital converter 175 receives the amplified analog signals from the amplifier 174. The analog-to-digital converter 175 converts the analog signals to digital signals. The analog-to-digital converter 175 is configurable in accordance with the configuration data 110. In other words, the configuration data 110 can determine whether the analog-to-digital converter 175 acts as an 8-bit, 16-bit, 32-bit, etc. analog-to-digital converter. The analog-to-digital converter outputs the digital signals to the filter 176 and to the data registers 184.

The filters 176 receive the digital signals from the analog-to-digital converter 175. The filters 176 filter the digital signals with one or more of low pass filters, bandpass filters, and high pass filters. The filters are configurable in accordance with the configuration data 110. In other words, the configuration data 110 determines the types of filters and their cutoff frequencies. In alternative embodiments, the filter 176 is an analog filter that can filter analog signals prior to conversion to digital signals. The filters 176 output the filtered signals to the arithmetic logic unit 178 and to the data registers 184.

The arithmetic logic unit 178 generates feature values for the various types of features to be provided to the classifier 112. The arithmetic logic unit 178 takes the filtered digital signals and generates the various feature values by performing arithmetic functions on the digital signals. In one example, the features can include one or more of instantaneous acceleration for each of the axes, average acceleration for each of the axes, mean normal acceleration, instantaneous angular, a mean angle, a number of zero crossings, a peak to peak range of acceleration, a peak to peak range of angular motion for the various axes, a peak to peak range of mean normal acceleration, a peak to peak range of mean normal angular velocity, average long-term acceleration, average long-term angular motion, energy values, intensity of motion for each of the various axes, a total intensity, or other types of features that can be computed based on digital acceleration and angular motion data. The arithmetic logic unit 178 is configurable in accordance with the configuration data 110. The arithmetic logic unit can be adjusted to compute new features or to cease computing old features based on updated configuration data. The arithmetic logic unit outputs the feature values to the feature registers 180 and to the data registers 184.

The feature registers 180 store the feature values in feature sets or feature vectors. The feature sets can be provided to the classifier 112 so that the classifier 112 can classify a context of the electronic device for each feature set. The feature registers 180 are configurable in accordance with the configuration data 110. The feature registers 180 can be adjusted to store selected features in accordance with the current state of the classifier 112. If the classifier is updated to receive different numbers of features and/or different types of features, then the feature registers 180 are also updated to store the feature values in their proper sets. The feature registers 180 provide feature sets including feature values for each of a plurality of features to the classifier 112 and to the data registers 184.

The classifier 112 receives feature sets from the feature registers 180. For each feature set, the classifier 112 generates a classification. The classification classifies a current context of the electronic device 102 based on the feature sets and the current classifier algorithm of the classifier 112. The classifier 112 is configurable in accordance with the configuration data 110. When a new classifier is generated by the sensor configuration system 106, the classifier 112 is rewritten or reprogrammed in accordance with the new classifier. The classifier 112 outputs the classification data to the data registers 184 and to the interrupt generator 188.

The configuration registers 177 store the configuration data 110 for the sensor unit 104. The configuration data 110 includes the classifier 112, the settings for the feature registers 180, the settings for the arithmetic logic unit 178, the settings for the filter 176, and the settings for the analog-to-digital converter 175. The sensor manager 158 of the electronic device 102 updates the configuration registers with new configuration data provided by the cloud-based sensor configuration system. Accordingly, the sensor manager 158 is able to write data to the configuration registers 177 in order to change the configuration settings of the sensor unit 104.

The data registers 184 provide their various data to the bus 186. The data stored by the data registers 184 includes the digitized sensor signals, filtered digital sensor signals, feature values generated by the arithmetic logic unit 178, feature sets stored by the feature registers 180, and classification data provided by the data registers 184. The bus 186 provides all of these data to the sensor manager 158. The sensor manager 158 can then further process the data, such as by generating labels. The sensor manager 158 can then output the sensor data to the sensor configuration system 106.

The interrupt generator 188 generates interrupts based on the classification data. The interrupt generator one provides the interrupts to the sensor manager 158. The sensor manager 158 can utilize the interrupt data to assist in generating labels for the feature sets.

A sensor unit 104 can include many other sensor types, components, and configurations of components in accordance with principles of the present disclosure without departing from the scope of the present disclosure.

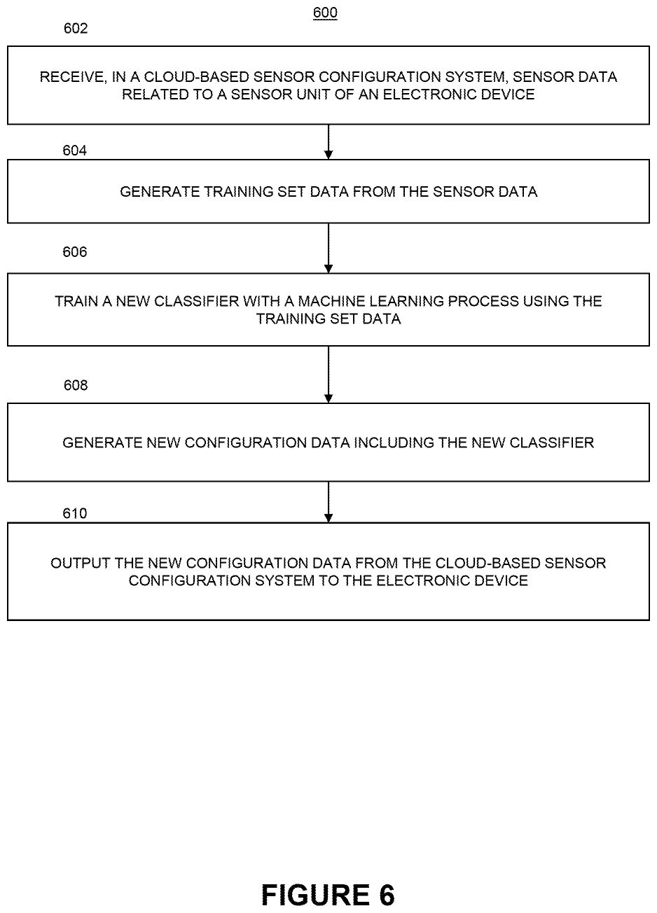

FIG. 6 is a flow diagram of a method 600, according to one embodiment. At 602, the method 600 includes receiving, in a cloud-based sensor configuration system, sensor data related to a sensor unit of an electronic device. At 604, the method 600 includes generating training set data from the sensor data. At 606, the method 600 includes training a new classifier with a machine learning process using the training set data. At 608, the method 600 includes generating new configuration data including the new classifier. At 610, the method 600 includes outputting the new configuration data from the cloud-based sensor configuration system to the electronic device.

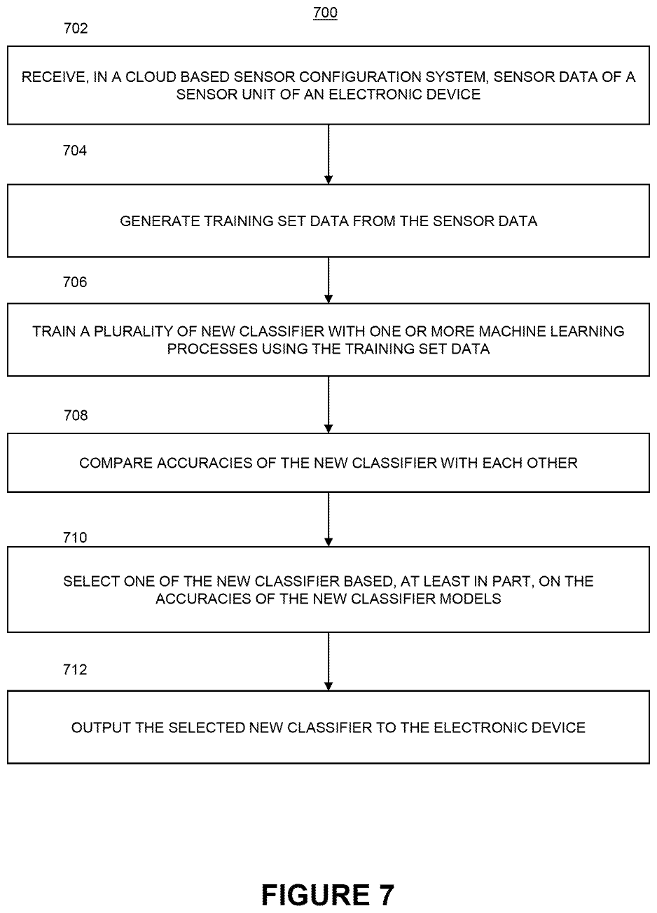

FIG. 7 is a flow diagram of a method 700, according to one embodiment. At 702, the method 700 receiving, in a cloud based sensor configuration system, sensor data of a sensor unit of an electronic device. At 704, the method 700 includes generating training set data from the sensor data. At 706, the method 700 includes training a plurality of new classifiers with one or more machine learning processes using the training set data. At 708, the method 700 includes comparing accuracies of the new classifiers with each other. At 710, the method 700 includes selecting one of the new classifiers based, at least in part, on the accuracies of the new classifiers. At 712 the method 700 includes outputting the selected new classifier to the electronic device.

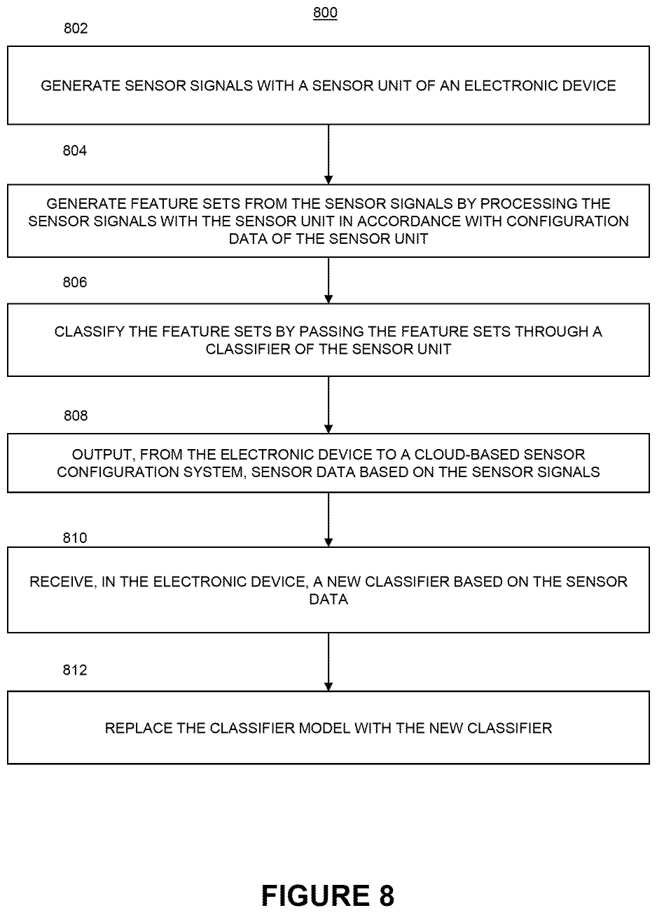

FIG. 8 is a flow diagram of a method 800, according to one embodiment. At 802, the method 800 includes generating sensor signals with a sensor unit of an electronic device. At 804, the method 800 includes generating feature sets from the sensor signals by processing the sensor signals with the sensor unit in accordance with configuration data of the sensor unit. At 806, the method 800 includes classifying the feature sets by passing the feature sets through a classifier of the sensor unit. At 808, the method 800 includes outputting, from the electronic device to a cloud-based sensor configuration system, sensor data based on the sensor signals. At 810, the method 800 includes receiving, in the electronic device, a new classifier based on the sensor data. At 812 the method 800 includes replacing the classifier with the new classifier.

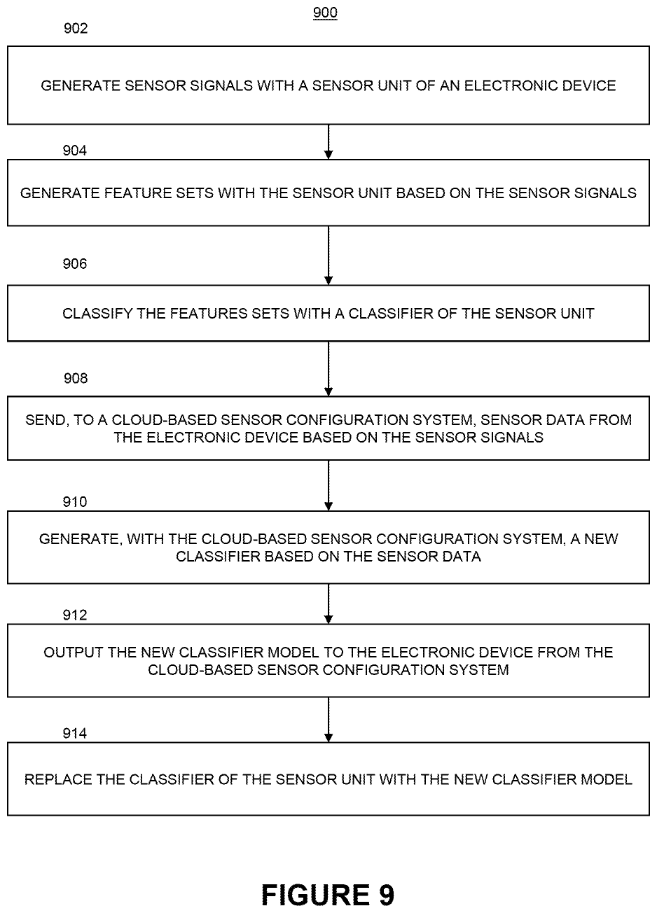

FIG. 9 is a flow diagram of a method 900, according to one embodiment. At 902, the method 900 includes generating sensor signals with a sensor unit of an electronic device. At 904, the method 900 includes generating feature sets with the sensor unit based on the sensor signals. At 906, the method 900 includes classifying the features sets with a classifier of the sensor unit. At 908, the method 900 includes sending, to a cloud-based sensor configuration system, sensor data from the electronic device based on the sensor signals. At 910, the method 900 includes generating, with the cloud-based sensor configuration system, a new classifier based on the sensor data. At 912 the method 900 includes outputting the new classifier to the electronic device from the cloud-based sensor configuration system. At 914 the method 900 includes replacing the classifier of the sensor unit with the new classifier.

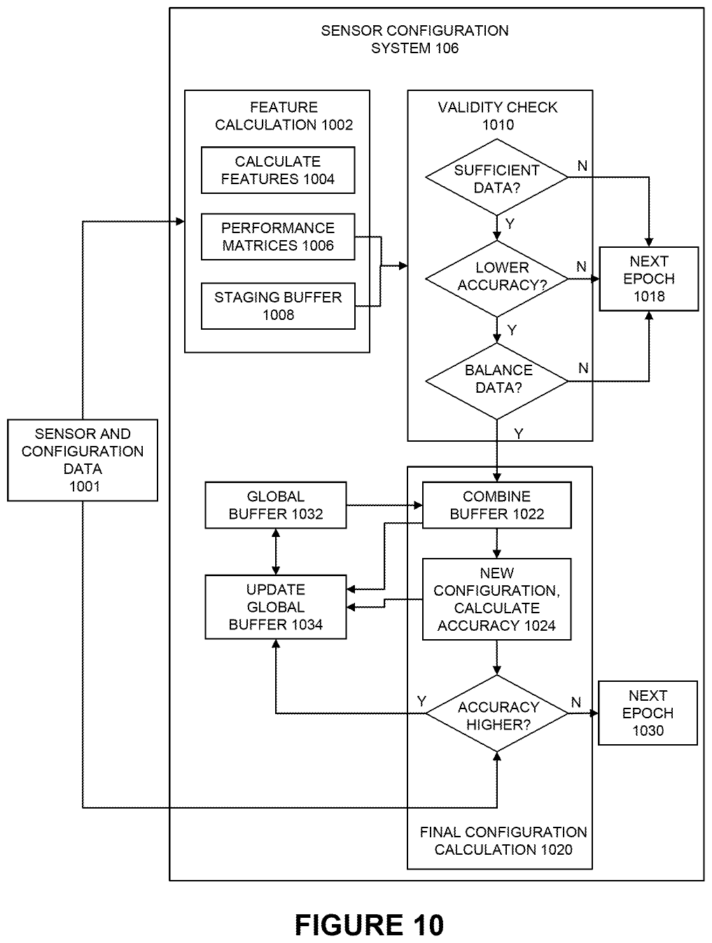

FIG. 10 is a block diagram of a cloud-based sensor configuration system 106, according to one embodiment. The sensor configuration system includes a feature calculation stage 1002, a validity check stage 1010, and a final configuration calculation stage 1020. The sensor configuration system utilizes a staging buffer 1008 and global buffer 1032.

In one embodiment, when sensor and configuration data 1001 is received from the electronic device 104, or from another type of gateway, the sensor configuration system 106 initializes the feature calculation stage 1002. The feature calculation stage receives the sensor and configuration data 1001 and calculates features at 1004 from the sensor and configuration data. The feature calculation stage generates performance matrices from the configuration data at 1006. The feature calculation stage 1002 updates the staging buffer with the new feature data.

In one embodiment, the feature data and the performance matrices are provided to the validity check stage 1010. The validity check stage 1010 first determines whether there is a sufficient amount of data. If there is a sufficient amount of data, the validity check stage 101 determines whether the accuracy is lower. If the accuracy is lower, the validity check stage 1010 determines whether the data is balanced for all classes. If the data is balanced, the cloud based sensor configuration system 106 moves to the final configuration calculation stage 1020. If the data is not sufficient, if the accuracy is not higher, or if the data is not balanced, the sensor configuration system 106 proceeds to await the next epoch at 1018.

At the final configuration calculation stage 1020, at 1032 the combine buffer receives data from the validity check and the global buffer 1032. At 1024, new configuration data is generated, including new filter selections and new feature selections. The new configuration is trained and new performance parameters are calculated. The final configuration calculation stage 1020 compares the new configuration accuracy and performance parameters with the current configuration. If the accuracy is not higher, the sensor configuration system 106 awaits a new epoch at 1030. If the accuracy is higher, the result is that the new configuration will be pushed to the sensor unit. The global buffer 1032 is updated at 1034.

One embodiment is an electronic device including a sensor unit. The sensor unit includes a classifier. The sensor unit is configured to generate sensor signals, to generate feature sets by processing the sensor signals, and to classify the feature sets by passing the feature sets through the classifier. The electronic device includes a cloud communication interface configured to output, to a cloud-based sensor configuration system, sensor data based on the sensor signals and to receive, from the cloud-based sensor configuration system, new configuration data including a new classifier based on the sensor data. The electronic device includes a sensor manager configured to replace the classifier of the sensor unit with the new classifier.

Further details regarding reconfigurable sensors are found in U.S. Pat. Nos. 10,142,789 and 10,260,877. U.S. Pat. Nos. 10,142,789 and 10,260,877 are incorporated herein by reference in their entireties.

The various embodiments described above can be combined to provide further embodiments. Aspects of the embodiments can be modified, if necessary, to employ concepts of the patents noted above to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
receiving, in a cloud-based sensor configuration system, sensor data related to a sensor unit of an electronic device;
generating training set data from the sensor data;
training a new classifier with a machine learning process using the training set data;
generating new configuration data including the new classifier; and
outputting the new configuration data from the cloud-based sensor configuration system to the electronic device.

2. The method of claim 1, wherein the sensor data includes:
a plurality of feature sets generated from sensor signals of the sensor unit; and
a plurality of labels each labeling a context of a respective feature set, wherein the training set data includes the feature data and the label data.

3. The method of claim 1, wherein the new classifier is configured to receive feature sets and to classify, for each feature set, a context of the electronic device based on the feature set.

4. The method of claim 3, further comprising:
measuring an accuracy of the new classifier;
comparing an accuracy of the new classifier to an accuracy of a current classifier currently installed in the sensor unit; and
selecting the new classifier to be included in the new configuration data based, in part, on the comparison of the accuracy of the new classifier to the accuracy of the current classifier.

5. The method of claim 1, further comprising selecting new filter settings for a filter of the sensor unit based on the sensor data, wherein the new configuration data includes the new filter settings.

6. The method of claim 1, further comprising selecting new feature set generation settings for an arithmetic logic unit of the sensor unit in accordance with the new classifier, wherein the new configuration data includes the new feature set generation settings.

7. The method of claim 1, further comprising selecting new sampling rate data for the sensor unit based on the sensor data, wherein the new configuration data includes the new sampling rate data.

8. The method of claim 7, further comprising replacing, in the sensor unit, current configuration data of the sensor unit with the new configuration data, wherein the current configuration data includes a current classifier.

9. The method of claim 1, wherein the classifier includes a decision tree model.

10. A method, comprising:
receiving, in a cloud based sensor configuration system, sensor data of a sensor unit of an electronic device;
generating training set data from the sensor data;
training a plurality of new classifiers with one or more machine learning processes using the training set data;
comparing accuracies of the new classifiers with each other;
selecting one of the new classifiers based, at least in part, on the accuracies of the new classifiers; and
outputting the selected new classifier to the electronic device.

11. The method of claim 10, wherein the selected new classifier is configured to receive input feature sets having different a different number of features than a current classifier currently installed in the sensor unit.

12. The method of claim 10, wherein the selected new classifier is configured to receive features sets generated from sensor signals of the sensor unit and to classify, for each feature set, a context of the electronic device.

13. The method of claim 10, further comprising maintaining a staging buffer and a global data buffer.

14. A method, comprising:
generating sensor signals with a sensor unit of an electronic device;
generating feature sets from the sensor signals by processing the sensor signals with the sensor unit in accordance with configuration data of the sensor unit;
classifying the feature sets by passing the feature sets through a classifier of the sensor unit;
outputting, from the electronic device to a cloud-based sensor configuration system, sensor data based on the sensor signals;
receiving, in the electronic device, a new classifier based on the sensor data; and
replacing the classifier with the new classifier.

15. The method of claim 14, wherein the sensor data includes the feature sets.

16. The method of claim 14, further comprising generating, with the electronic device, a respective label for each respective feature set with the electronic device, wherein the sensor data includes the labels.

17. The method of claim 14, further comprising:
receiving new configuration data from the cloud-based sensor configuration system; and
replacing the configuration data of the sensor unit with the new configuration data.

18. The method of claim 17, wherein the new configuration data includes one or more of:
filter parameters for a filter of the sensor unit;
a sampling rate for sampling the sensor signals of the sensor unit; and
a window size indicating a time length for gathering sensor signals for each feature set.

19. An electronic device, comprising:
a sensor unit including a classifier, wherein the sensor unit is configured to generate sensor signals, to generate features sets by processing the sensor signals, and to classify the feature sets by passing the feature sets through the classifier;
a cloud communication interface configured to output, to a cloud-based sensor configuration system, sensor data based on the sensor signals and to receive, from the cloud-based sensor configuration system, new configuration data including a new classifier based on the sensor data; and
a sensor manager configured to replace the classifier of the sensor unit with the new classifier.

20. The electronic device of claim 19, wherein the sensor unit is a motion sensor unit including one or more motion sensors, wherein the sensor signals are motion sensor signals.

21. The electronic device of claim 19, wherein the sensor data includes the feature sets and a respective label for each feature set.

22. The electronic device of claim 21, wherein the sensor manager is configured to generate the labels, wherein each label corresponds to a classification of the corresponding feature set.

23. The electronic device of claim 19, wherein the sensor unit includes a configurable filter, wherein the new configuration data includes filter settings for the configurable filter.

24. The electronic device of claim 19, wherein the new configuration data includes sampling rate configuration data for the sensor unit.

25. A method, comprising:
generating sensor signals with a sensor unit of an electronic device;
generating feature sets with the sensor unit based on the sensor signals;
classifying the features sets with a classifier of the sensor unit;
sending, to a cloud-based sensor configuration system, sensor data from the electronic device based on the sensor signals;
generating, with the cloud-based sensor configuration system, a new classifier based on the sensor data;
outputting the new classifier to the electronic device from the cloud-based sensor configuration system; and
replacing the classifier of the sensor unit with the new classifier.

26. The method of claim 25, wherein the electronic device is a smart phone.

27. The method of claim 26, wherein the electronic device is a smart watch.
